(19) United States
(12) Patent Application Publication
(10) Pub. No.: US 2004/0069241 A1
(43) Pub. Date: Apr. 15, 2004

(54) Cat can't jump-device for restraining small animals from jumping

(76) Inventor: Maureen Diane Falwell, Austin, TX (US)

Correspondence Address: MAUREEN D. FALWELL, #100, 12407 N. MOPAC, PMB 263, AUSTIN, TX, 78758, US

(21) Appl. No.: 10/336,370

(22) Filed: Jan. 3, 2003

Related U.S. Application Data
(60) Provisional application No. 60/417,489, filed on Oct. 10, 2002.

(51) Int. Cl. A01K 27/00

(52) U.S. Cl. 119/795

(57) ABSTRACT

A animal restraint (10) is comprised of a tether (14) with a device (12) for attaching to the cat's collar on one end and a weight (13) attached to the other end to provide the animal with some free roaming ability while preventing them from jumping onto furniture or over fences.

This application claims the benefit of Provisional Patent Application No. 60/417,489 filed Oct. 10, 2002.

### BACKGROUND OF THE INVENTION

1. Field of the Invention

This invention relates specifically to a device used to prevent cats from jumping over fences or onto or into areas from which the pet owner wishes to restrict the cat. Specifically this invention limits or prevents the cat's ability to jump, while allowing the cat to move freely about the level areas of the yard or other enclosure.

2. Description of Prior Art

A wide variety of pet training and restraining devices are found in the art. For example, U.S. Pat. No. 6,412,442 to Bean; U.S. Pat. No. 6,164,245 to Johnson; U.S. Pat. No. 229,691 to Gerard; U.S. Pat. No. 207,963 to Haliner and Lindquist; U.S. Pat. No. 160,134 to Wilson; U.S. Pat. No. 843,543 to Matsumoto; U.S. Pat. No. 800,260 to Bellstedt are all illustrative of prior art. While these units may be suitable for the purposes for which they were designed, they would not be suitable for the purposes of the present invention. Several types of animal tethers have been proposed—for example, U.S. Pat. No. 6,412,442 to Bean. These devices have the tether fixed to a permanent object on one end, thus restricting the animals overall movement and enabling tangling in objects within the reach of the tether. Restraining devices without secured ends have been proposed—for example, U.S. Pat. No. 229,691 to Girard. These devices require the installation of a special enclosure and are only for use outside. Other restraining devices with weights instead of secured ends have been proposed as well—for example, U.S. Pat. No. 843,543 to Matsumoto. These devices are designed to substitute for fixed end tethers for instances where a suitable stationary object isn't present. These devices do not provide the animal with the feeling of freedom from the ability to move.

### OBJECTS AND ADVANTAGES

Several objects and advantages of the present invention are to provide an animal restraint that is:

(a) not attached to a fixed location

(b) capable of restraining the animal without the installation of a special enclosure

(c) capable of preventing small animals from jumping onto undesired objects

(d) capable of preventing small animals from jumping over obstacles such as fences

(e) not likely to destroy flowers or other property

Specifically, the present invention is designed to solve the problem of small animals, and cats in particular, jumping onto furniture or over fences. By preventing the cat from jumping over the fence, the present invention allows the cat to roam freely about the fenced property. This free roaming feature allows the animal to feel free. Additionally, the free roaming characteristic prevents tangles that come from fixed end tethers, such as those represented in the prior art. The present invention is also set apart from previous art in that it does not require the installation of a special enclosure and it can be used indoors.

Further objects and advantages of the present invention will become apparent from a consideration of the drawings and ensuing description.

### DESCRIPTION OF DRAWINGS

The accompanying drawings illustrate the invention. In such drawings:

FIG. 1 is a side plan view of the present invention

FIG. 2 is a top perspective view of the present invention

### DETAILED DESCRIPTION OF THE PREFERRED EMBODIMENTS

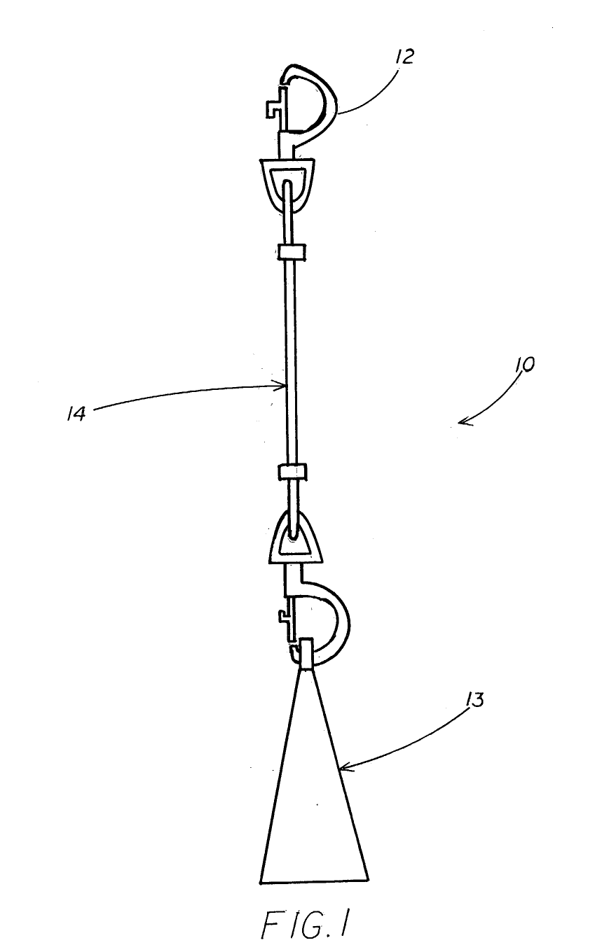

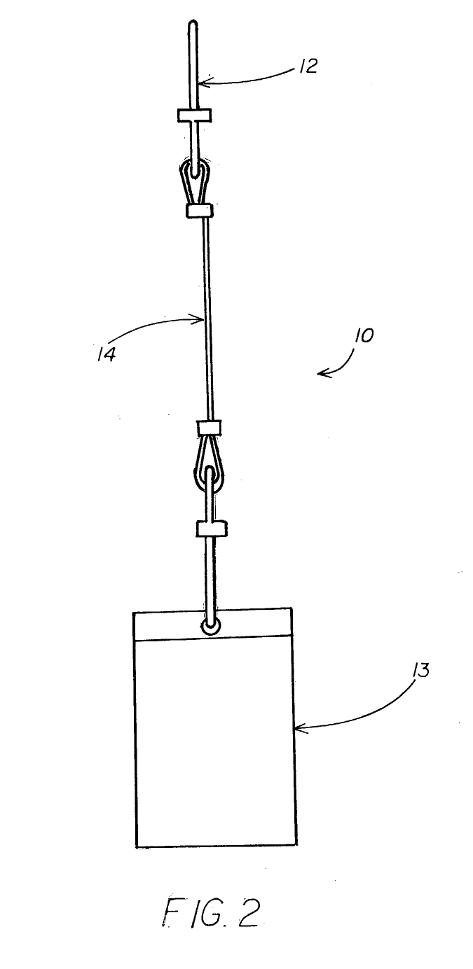

A typical embodiment of the animal restraint 10 is shown in FIG. 1 and FIG. 2. The figures illustrate the animal restraint 10 comprised of a tether 14 with a device 12 for attaching to the animal's collar or harness on one end. A weight 13 is attached to the other end of the tether 14 to provide restriction of movement to prevent the animal from jumping onto furniture or over fences. Tether 14 is made of a strong flexible material. The weight 13 has several embodiments and is shown here as a weighted bag.

### REFERENCE NUMBERS IN DRAWINGS

10 Cat Can't Jump device

12 attaching device connecting 14 to pet's collar or harness

13 weight connected to 14

14 flexible tether

### SUMMARY

A animal restraint (10) is comprised of a tether (14) with a device (12) for attaching to the cat's collar on one end and a weight (13) attached to the other end to provide the animal with some free roaming ability while preventing them from jumping onto furniture or over fences.

### OPERATION OF THE INVENTION

To use the Cat Can't Jump device 10, the following steps should be taken:

1. Attach the device 10 to the animal's collar or harness using attaching device 12

2. If to be used outside, release animal into fenced property

3. If to be used inside, release animal indoors

The Cat Can't Jump device 10 can be used for extended periods of time since it only limits the animal's jumping ability, but doesn't immobilize the animal.

### CONCLUSION, RAMIFICATIONS, AND SCOPE OF INVENTION

Thus the reader can see that the Cat Can't Jump device 10 provides many advantages over conventional animal tethers. By eliminating the fixed end, the animal will not become entangled in obstructions such as trees, bushes or play equipment. Providing cats the ability to roam around a fenced yard as if they are free increases the health of the cat. The weight prevents the cat from jumping over the fence, thus preventing the cat from becoming a stray. The weight also can be used indoors to prevent the animal from jumping on counters, tables and other furniture, with out penning the animal in an uncomfortable box.

While the above description contains many specificities, these should not be construed as limitations on the scope of the invention, but rather as an exemplification of one preferred embodiment thereof. Many other variations are possible. For example the tether 14 could be connected directly to the weight 13, or by an additional fastener. Also, the weight 13 can be of many different shapes, sizes, weights or other configurations.

Thus the scope of the invention should be determined by the appended claims and their legal equivalents, rather than by the examples given.

It will be understood that each of the elements described above, or two or more together may also find a useful application in other types of methods differing from the type described above.

While certain novel features of this invention have been shown and described are pointed out in the annexed claims, it is not intended to be limited to the details above, since it will be understood that various omissions, modifications, substitutions and changes in the forms and details for the device illustrated and in its operation can be made by those skilled in the art without departing in any way from the spirit of the present invention.

Without further analysis, the foregoing will so fully reveal the essence of the Cat Can't Jump device 10 that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. An animal restraining device for attaching to the animals collar or harness:
a) Means in combination with and for limiting the ability of the animal to run and jump over or onto objects of size comprising an attaching device for connecting to the animal with a tether connected at the other end to a weight.
